(19) United States
(12) Patent Application Publication
(10) Pub. No.: US 2013/0078593 A1
(43) Pub. Date: Mar. 28, 2013

(54) Orthodontic Appliance and Method of Orthodontic Treatment with Same

(71) Applicant: ORMCO CORPORATION, Orange, CA (US)

(72) Inventor: Craig A. Andreiko, Alta Loma, CA (US)

(73) Assignee: ORMCO CORPORATION, Orange, CA (US)

(21) Appl. No.: 13/631,062

(22) Filed: Sep. 28, 2012

Related U.S. Application Data
(60) Provisional application No. 61/540,251, filed on Sep. 28, 2011.

(51) Int. Cl. A61C 7/08

(52) U.S. Cl. 433/6; 433/24

(57) ABSTRACT

An orthodontic aligner of the type that is deformable from its initial shape to a deformed shape when fitted upon a patient's teeth in order to apply a load to the teeth to move the teeth to an orthodontically preferred position is made from a polymeric material that generates a continuing elastic return stress driving toward the initial shape after a substantial period of continuous deformation, such as longer than one day and up to or exceeding two weeks. Elastic stress loads applied to teeth over such durations cause greater remodeling of the bone adjacent to a tooth's roots than is possible with known aligner materials.

### TECHNICAL FIELD

The present invention is directed to an orthodontic appliance and particularly to orthodontic aligners.

### BACKGROUND

Orthodontic appliances represent a principal component of corrective orthodontic treatment devoted to improving a patient's occlusion. In conventional orthodontic treatment, an orthodontist or an assistant affixes an orthodontic appliance, such as, orthodontic brackets, to the patient's teeth and engages an archwire into a slot of each bracket. The archwire applies corrective forces that coerce the teeth to move into orthodontically correct positions. Traditional ligatures, such as small elastomeric O-rings or fine metal wires, are employed to retain the archwire within each bracket slot. Due to difficulties encountered in applying an individual ligature to each bracket, self-ligating orthodontic brackets have been developed that eliminate the need for ligatures by relying on a movable latch or slide for captivating the archwire within the bracket slot. Conventional orthodontic brackets are ordinarily formed from stainless steel, which is strong, nonabsorbent, weldable, and relatively easy to form and machine. Patients undergoing orthodontic treatment using metal orthodontic brackets, however, may be embarrassed by the visibility of metal, which is not cosmetically pleasing. To address the unsightliness of metal brackets, certain conventional orthodontic brackets incorporate a bracket body of a transparent or translucent non-metallic material, such as a clear or translucent polymer or a clear or translucent ceramic, that assumes the color or shade of the underlying tooth.

Alternatives to orthodontic brackets include appliances that are not required to be affixed to the patient's teeth. Such appliances include so-called “aligners” that are interchangeable by the patient during treatment. Accordingly, the clinician may prescribe a series of aligners, which are generally placed over but are not themselves adhesively secured or otherwise attached to the patient's teeth, to move one or more teeth from their original position to their aesthetically pleasing position. Typically, a series of aligners is required to fully treat the patient because the degree of movement produced by each individual aligner is limited. As such, when used in a series, each aligner in the series may be designed to fulfill a portion of the treatment process or move one or more teeth over a portion of the entire distance toward the desired position.

One aligner system is the Invisalign® system available from Align Technology, Inc. The Invisalign® system includes removable aligners that are to be worn by the patient. Generally, these aligners are clear or transparent polymer orthodontic devices that are removably positioned over the teeth of the maxilla and/or the teeth of the mandible. In this system, as treatment progresses, the patient wears an a first aligner having a specific prescription for a period of several days or few weeks, then removes the first aligner and replaces it with a second aligner having a second, different prescription. Each aligner is responsible for moving the teeth toward their final predetermined or aesthetically correct position.

Patients undergoing treatment with these types of systems often experience a treatment that does not progress as originally anticipated by the clinician. Specifically, at some point during treatment the patient cannot fit the next successive aligner in the series onto his or her teeth. This is generally due to one or more or each of the previous aligners' failing to move one or more of the patient's teeth to the exact prescribed location. When a previous aligner fails to generate the prescribed orientation of the teeth, the subsequent aligner may not fit exactly as planned. As a result, the subsequent aligner may not move the tooth to its final, predetermined position. The tooth is thus at a location other than where it ought to be according to the treatment plan or is misplaced. An accumulation of these individual misplacement errors often prohibits placement of the next aligner in the series. It is typically necessary for the treatment process to be “rebooted” when this occurs. That is, the orthodontist may need to determine the actual position of the teeth by taking a mold thereof or by scanning the teeth. Once the actual tooth position is known, the misplacement error can be determined and one or more additional aligners may be prescribed to correct the uncorrected error of previous aligners. In this way, the new, additional aligners may place the patient back-on-track with the original treatment process. Correcting for errors in movement in the initial treatment process is undesirable as it requires additional visits to the orthodontist's office as well as extends the treatment time, and increases the costs associated with treatment.

Consequently, there is a need for an orthodontic appliance that moves teeth to their predetermined positions such that error correction is less frequently required. There is also a need for polymeric orthodontic appliance that can endure the biochemical environment found in the oral environment without substantial degradation in mechanical properties or aesthetics, and that does not otherwise negatively impact the patient's teeth during treatment.

### SUMMARY OF THE INVENTION

The above described needs are met in accordance with principles of the present invention, which in one aspect features an orthodontic appliance such as an aligner, or any other appliance of continuously polymeric material having two or more tooth-conforming cavities, which in use is elastically deformed from an initial shape to a deformed shape when fitted upon a patient's teeth, so that the polymeric material generates an initial elastic return stress. Unlike the materials used in the prior art, the appliance material is selected such that it is capable of generating a continuing elastic return stress driving the polymeric material from a deformed shape toward its initial shape even after the polymeric material has been continuously deformed to said deformed shape for more than one day, and in some embodiments, for periods of two weeks or longer.

In one embodiment, an appliance in accordance with this aspect of the invention generates initial, continuing and ongoing elastic return stresses sufficient to cause remodeling of bone adjacent to the tooth's roots after two weeks, and thereby can generate greater and more accurate tooth movements than appliances made of elastic materials which plastically deform after a short period of time.

In embodiments disclosed herein, suitable polymeric material are identified, which are characterized by viscoelastic material properties, and a stress relaxation time that is long enough to generate continuing stress sufficient to remodel bone adjacent to an engaged tooth on or after 20 days after the initial installation of the appliance.

In further aspects, the invention features a method of moving teeth of a patient, comprising applying an appliance as described above to the patient's teeth, so that the appliance elastically deforms and generates an initial and continuing elastic return stress over a period of greater than one day, and in some embodiments, for periods of two weeks or longer.

### BRIEF DESCRIPTION OF THE DRAWINGS

The accompanying drawings, which are incorporated in and constitute a part of this specification, illustrate embodiments of the invention and together with the detailed description given below, serve to explain various aspects of the invention.

FIG. 1 is a perspective view of one embodiment of the invention;

FIG. 2 is a photograph of a test fixture used to test various commercially available polymeric materials;

FIG. 3 is a photograph illustrating the deformation or configuration of strips of polymeric materials obtained through the use of the test fixture depicted in FIG. 2 after two-week (14 day), 5-day, and 2-day tests;

FIG. 4 illustrates the anatomy of a human tooth and surrounding tissue; and

FIG. 5 illustrates an orientation of the tooth of FIG. 4 after an aligner is positioned thereon.

### DETAILED DESCRIPTION

In general, one embodiment of the invention includes an orthodontic appliance capable of moving teeth according to a predetermined treatment plan. In particular, the orthodontic appliance may move one or more teeth from one orientation to another which advances the overall orientation of the teeth toward their final aesthetic positions.

In one embodiment of the invention, a series of individual orthodontic appliances may be utilized for complete orthodontic treatment. Accordingly, each appliance in the series may move one or more teeth a prescribed amount. Cumulatively, these individual amounts may result in complete treatment of the patient's malocclusion.

By way of example only, in one embodiment, the orthodontic appliance may include an aligner. Such aligners may be similar to those disclosed in U.S. Pat. No. 6,450,807, which is incorporated by reference herein in its entirety, but differ in the polymer from which it is made, as is described in detail below. The aligner may be configured to fit over or encapsulate multiple teeth on one of the mandible or maxilla. It is known that such an aligner may not be secured to the patient's teeth, such as with an adhesive or a fastener. Instead, these aligners may be designed to couple to one or more teeth by virtue of the shape of the aligner itself. In this regard, the patient may be able to remove and reattach the aligner during treatment without the aid of the orthodontist.

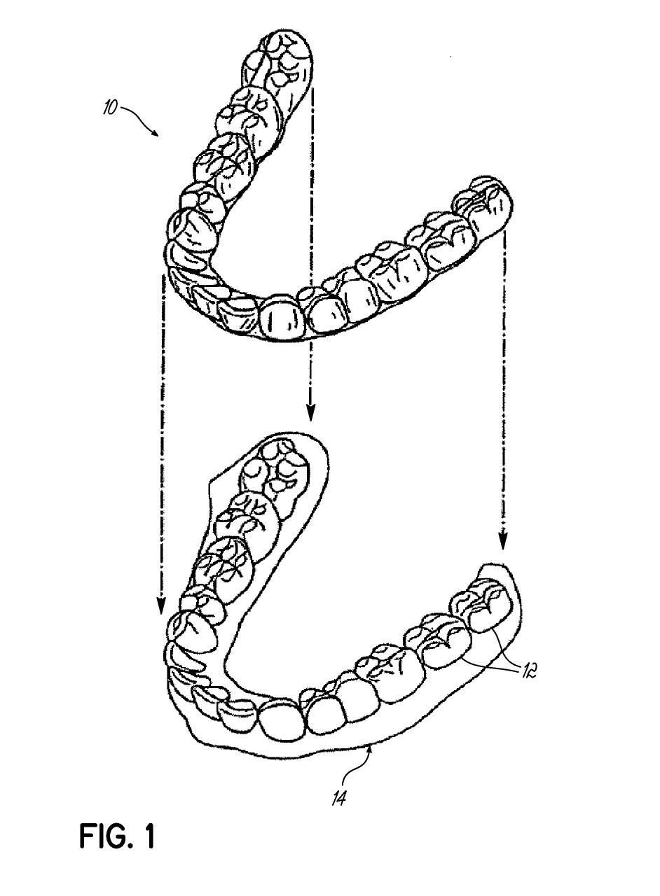

With reference to FIG. 1, in one embodiment, an aligner 10 may be one of a series of aligners that are prescribed to treat a patient's malocclusion or a portion thereof by moving one or more teeth 12 on the patient's mandible 14 from the misaligned position toward their orthodontically correct position. For instance, the aligner 10, according to one embodiment of the invention, may move a single tooth 12 from one orientation to another orientation. This movement may be predetermined according to a treatment plan that includes a starting orientation and a final orientation. The starting orientation may be the initial orientation before treatment begins or any of the subsequent, intermediate tooth orientations as determined by a previous aligner or another orthodontic device. The final orientation for any aligner 10 in a series of aligners may include a position that is intermediate between the starting orientation and the final orientation or it may be the aesthetically correct position for the tooth observed at the conclusion of treatment. In this regard, in one embodiment of the invention, a system for treating a malocclusion may include a series of aligners 10 differing in their configuration sufficient to fulfill a predetermined treatment plan. Accordingly, each respective aligner may incrementally move one or more teeth from their misaligned positions toward or to their aesthetically correct or final orientation. While embodiments of the invention include aligners that may not be secured to the patient's teeth with adhesives or such, it will be appreciated that the appliance, according to embodiments of the invention, are includes orthodontic appliances that are adhesively secured to the patient's teeth. Specifically, embodiments of the appliance may be adhesively joined to another orthodontic appliance and/or to the patient's teeth during orthodontic treatment.

Furthermore, though not shown, it will also be appreciated that the appliance may alternatively be used on the maxilla or on both the maxilla and mandible.

By way of example, the aligner 10 may be similar in shape to that shown in U.S. Pat. No. 6,450,807. In this regard, the aligner 10 may substantially conform to one or more of the teeth 12 on the jaw 14 over which the aligner is placed. The aligner 10 may encapsulate or nearly replicate the reverse shape of each tooth 12. However, there may be teeth 12 in contact with the aligner 10 that may not match or conform to the aligner 10. Accordingly, there may be nonalignment between one or more teeth 12 and the aligner 10. As a result of the lack of complete alignment between all of the teeth and the aligner 10, a portion of the aligner 10 may be deformed or strained elastically, and generate an elastic stress. The stress may be tensile, shear, or compressive in nature. This stress typically produces loads in an opposing direction on the respective teeth. During treatment, at least one tooth may move to at least partially alleviate the opposing load. In this manner, desired tooth movement may be achieved.

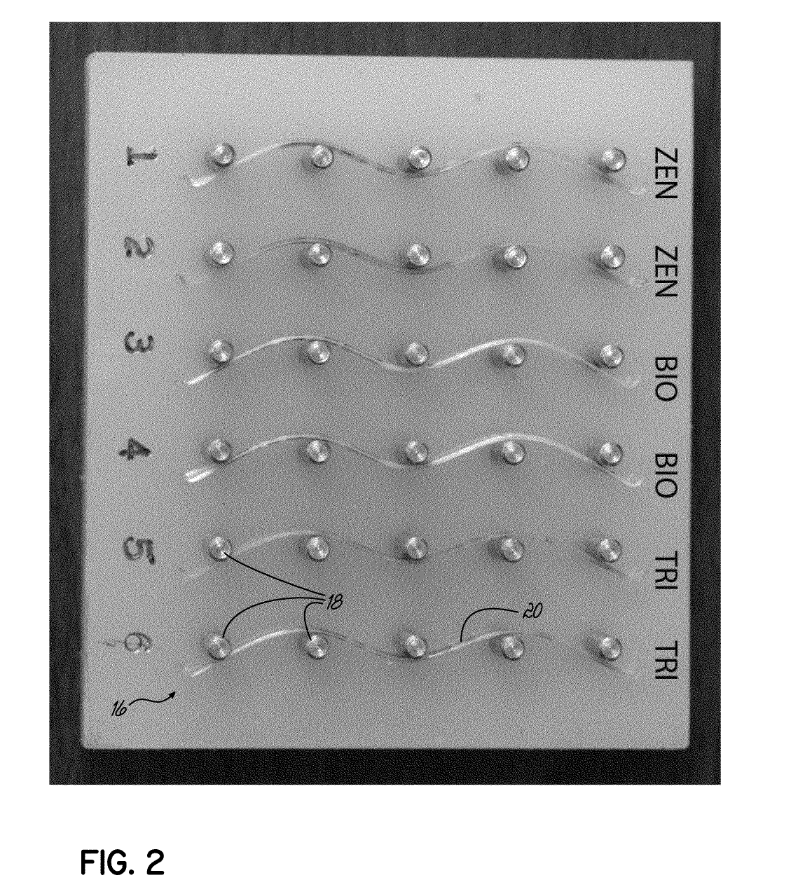

To better understand aligner mode of operation and the materials from which current aligners are manufactured, a number of commercially available polymers from which commercially available aligners are made, were tested to determine their resistance to plastic deformation under prolonged deformation in somewhat of a simulated oral environment. In this regard, straight strips (not shown) of each of the materials were cut from vacuum formed aligner analogs originally 0.030 inch (0.75 mm) thick. The polymers tested were 1) Zendura® available from Bay Materials LLC, California, 2) Biocryl available from Great Lakes Lab, and 3) Triplast from Adell Polymers. With reference to FIG. 2, a sinusoidal (to net a continuum of strains) test fixture 16 was designed to examine the material properties of three current aligner materials (above) in vitro. The fixture 16 consisted of thirty 0.125 inch diameter stainless steel pins 18 pressed into a plastic block on 0.5 inch centers. The fixture 16 consisted of six rows of five of the pins 18. FIG. 2 is a photo of the fixture 16 with the strips laced between the pins (2 strips of each material). The loaded test fixture 16 was placed in a 37° C. water bath (not shown).

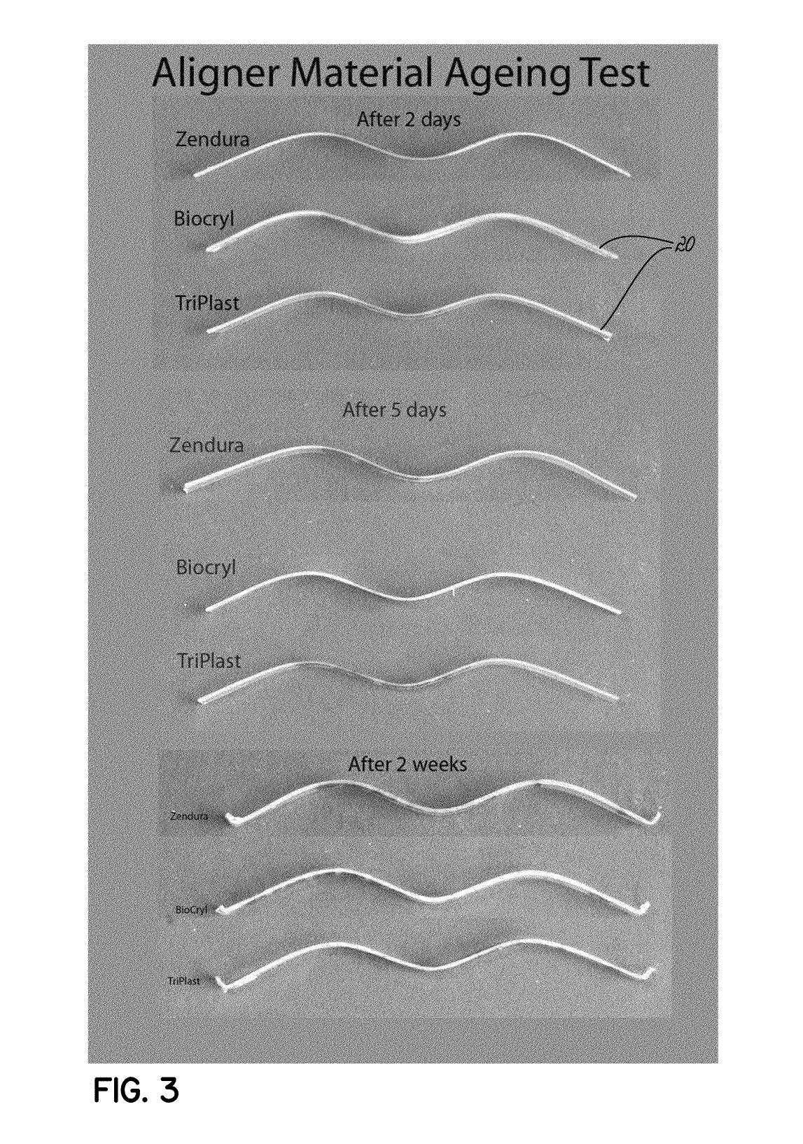

The typical recommended wear period for the aligners of the above-mentioned materials is about two weeks. As such, for an initial test, each of the strips 20 was held in the water bath laced between the pins 18 for a duration of two weeks. As is shown in FIG. 3, after two weeks, each of the strips 20 took a “set.” In other words, each polymeric strip 20 took on a plastically deformed shape dictated by the test fixture 16 and essentially conformed to that configuration permanently after two weeks. There was no observable elastic recovery to the initially straight configuration when the strips 20 were removed from the fixture 16.

As is also shown in FIG. 3, the same result was observed after reducing the test duration to 5 days. And, as shown, a 2-day test produced the same result as the 5- and 14-day tests. A 1-day test or 24-hour test (not shown) gave identical results. In sum, each polymeric strip 20 plastically deformed to a set position as determined by the test fixture after the time period indicated. It was observed that after as little as 24 hours in the fixture 16, none of the strips visually recovered a portion of their initial, straight shape.

Applicant observed that this characteristic of commercially used materials is problematic and has significant implications for orthodontic treatment. For example, without being bound by theory, as a consequence of the rapid plastic deformation of aligner material, it is thought that the elastic stress load applied by aligners made of these polymers decreases rapidly over the first 24 hours of use. In this regard, while the elastic stress load initially applied is sufficiently high to produce bone remodeling, after 24 hours in vitro, it is suspected that little, if any, load is applied to the teeth by these materials.

That is, commercially available aligners are nearly ineffective after 24 hours in the patient's mouth. However, it is known that aligners of these polymeric materials move teeth, though commercially available treatment systems have the above-mentioned problems that require them to be rebooted.

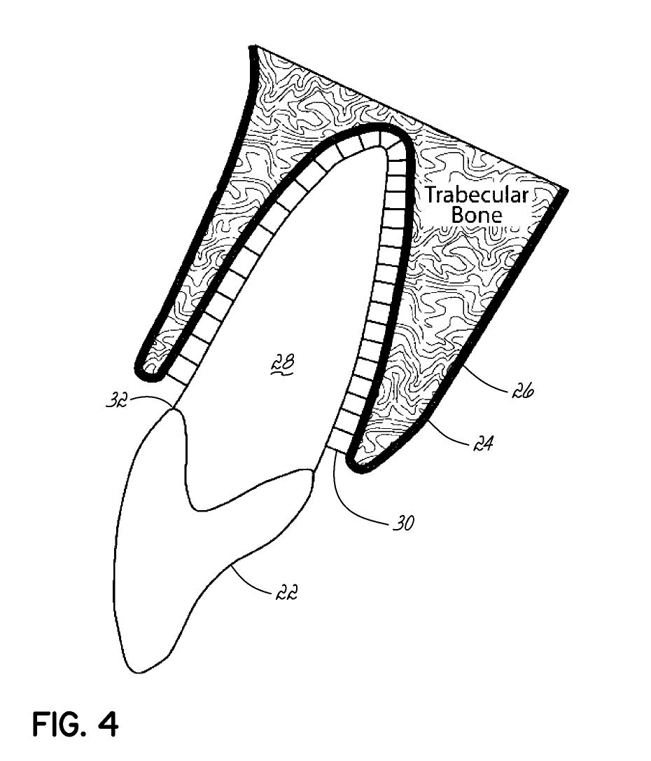

In this regard, the anatomy of the teeth and the surrounding supporting bone may serve to explain the movement of the teeth that is observed despite the now-identified limits of the current aligner materials and may also explain the aforementioned problems of current aligners and treatment with them. With reference to FIG. 4, it is known that a root 28 of a tooth 22 sits in a socket of lamina dura 24, which is a relatively thin layer of extremely hard, mostly avascular, cortical bone. The cortical bone is surrounded by a mass of soft, spongy, vascular or trabecular bone 26. The root 28 of the tooth 22 is attached to the bone 24 by a periodontal ligament (PDL) 30. The PDL 30 is typically narrowest (0.15 mm) at the middle third of the root 28 and is typically widest occlusally and at the root tip 32 (0.38 mm).

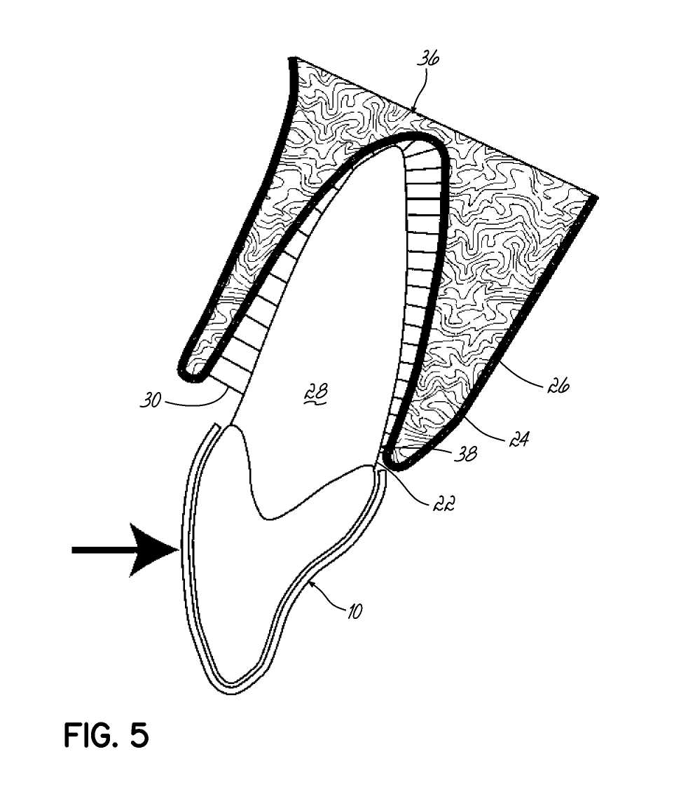

With reference now to FIG. 5, when an aligner 34 is placed on the tooth 22, it moves the tooth 22 until the PDL 30 is compressed against the lamina dura, for example, at 36 and 38. Because the PDL 30 has viscoelastic-like material properties, it yields under the load applied by the aligner 34. Viscoelasticity is a material property that describes the deformation of a material having both fluid-like, or viscous, and solid-like, or elastic, characteristics. The bone 24, 26 may also be thought of as having viscoelastic-like material properties, though the PDL 30 is more fluid-like and, consequently, less solid-like, than the adjacent bone 24, 26. The polymer of the aligner 34 may also have viscoelastic material properties in the oral environment.

Referring now to the polymeric aligner materials tested above in view of FIG. 5, it is observed that the polymers tested have viscoelastic material properties by which their elastic behavior is between that of the PDL 30 and the respective bone 24, 26. Based on this observation, while the PDL 30 yields under the initial load of the aligner 34, it is the aligner 34 that ultimately yields before the bone 24 remodels to any significant extent. In other words, in the conditions found in the oral environment, the initial elastic stress produced by the initially deformed polymeric aligner 34 is high enough to compress the PDL 30. However, that initial elastic stress in the aligner 34 is reduced by viscous flow. And, the rate of this stress reduction is high enough that the magnitude of the stress after one day may be lower than that required to maintain compression of the PDL 30. Thus, the load applied by the aligner 34 is insufficient to cause further tooth movement after one day from the start of treatment.

In further detail, taking into account the above description, and with continued reference to FIG. 5, an aligner 34 of the above-mentioned polymers compresses the PDL 30 up against the bone 24. After 24 hours, the aligner 34 plastically deforms to a new set position, as described above. As such, the aligner 34 takes a set before the bone 24 has a chance to remodel. It will be appreciated that it may take from between about 20 to about 40 days for the lamina dura to resorb from the trabecular bone side because of the increased vascularity there.

Once the aligner 34 sets, the load applied by the aligner 34 is significantly reduced as compared to the initial load or the load disappears altogether. As such, no additional appreciable tooth movement may occur after the aligner 34 takes a set. However, the plastically deformed aligner may hold the tooth 22 in a repositioned location while the bone 24 remodels away from the tooth 22. In this manner, it is thought that aligners made of the above-mentioned materials move teeth, though the movement is limited to a distance related to the thickness of the PDL 30. Therefore, use of the aligners made of these materials is limited in this regard. It may be concluded that current treatment plans that require an aligner of the above-mentioned polymers to move a tooth greater than is permitted by the thickness of the PDL 30 may be particularly susceptible to a failure and a “reboot,” as described above.

In view of the above, in one embodiment of the invention, the aligner 10 may be made of a polymer characterized by a modulus of elasticity that, while varying with temperature, maintains a modulus in the oral environment sufficient to move tooth for a time period greater than 24 hours after insertion to an oral environment. By way of example, the aligner 10 may be capable of applying loads sufficient to compress the PDL as the bone remodels over a period of several days. This may be, for example, on or after 20 days from the insertion of the aligner 10 into the oral environment. The aligner 10 according to embodiments of the present invention may thus be capable of moving teeth over a distance that is not limited by the thickness of the PDL.

Advantageously, according to embodiments of the invention, treatment may proceed at a more rapid pace in that the patient may not be required to have the treatment “rebooted.” Furthermore, fewer aligners in the series may be required, making treatment more cost effective.

In embodiments of the invention, it is anticipated that the polymer of the aligner may exhibit viscoelastic material properties as has been seen in prior art aligners. However, the polymer may be characterized by relatively high relaxation times compared to the polymers tested above. The relaxation time of a polymer is defined as the time necessary for the stress to fall to 0.37 of the initial stress. The exponential decay of the stress with time is given by σ=σ₀e^{-t/τ} where σ₀ is the initial stress, t is the time, and τ is the relaxation time. Stress relaxation is an Arrhenius phenomenon, which is described by the equation 1/τ=Ce^{-Q/RT}, where C is a pre-exponential constant, Q is the activation energy for viscous flow, R is the universal gas constant, and T is the absolute temperature.

By way of example, an aligner, according to the present invention, has an in vitro relaxation time that is at least about double that of the polymers tested above. By way of additional example, the aligner according to one embodiment of the present invention may have an in vitro relaxation time that is an order of magnitude greater than those of the polymers tested above. As such, the aligner may be capable of maintaining at least 37% of the initial load at installation for at least two weeks in the oral environment. It will be appreciated that 37% of the initial stress may be greater than the stress needed to move the tooth, that is, compress the PDL and generate remodeling of bone during this entire timeframe.

To that end, the aligner may be made of a polymeric material having a glass transition temperature that is equal to or exceeds about 30° C., for example, about 37° C., about 70° C., or about 100° C. By way of alternative example, the aligner may be made of a polymer, such as one or more thermoplastic or thermoset polymers or resins suitable for use in the human mouth. Exemplary polymers may include polyurethanes, ionomers, or polycarbonates. Other exemplary polymers include polysulphone, acrylic, polyamide, acrylonitrile-butadiene-styrene terpolymer, or polyethylene terephthalate. In a further example, the aligner may be at least one of polyoxymethylene, acrylonitrile, styrene acrylonitrile, styrene butadiene rubber, polyetheretherketone, or polyarylethereketone.

It will be appreciated that the aligner may be made entirely of one or more of the above mentioned polymers. That is, the aligner may be 100% polymer or polymer mixture.

Alternatively, the aligner may be layered. That is, two or more of the polymers listed above may be layered to reduce degradation of the underlying polymeric layer from direct exposure to the fluid found in the oral environment. In addition, the aligner may include a reinforcing agent, such as, glass particles or fibers or polymeric fibers.

While the present invention has been illustrated by a description of various embodiments and while these embodiments have been described in some detail, it is not the intention of the inventor to restrict or in any way limit the scope of the appended claims to such detail. Thus, additional advantages and modifications will readily appear to those of ordinary skill in the art. The various features of the invention may be used alone or in any combination depending on the needs and preferences of the user.

What is claimed is:

1. An orthodontic appliance for moving teeth of a polymeric material having an initial shape which defines two or more three-dimensional cavities, each said cavity corresponding to the shape of a crown of an individual tooth of a patient's mandible or maxilla, wherein the polymeric material has the property that after a day of use of the appliance in which it is deformed by fitting the appliance to the patient's teeth, the appliance will return to a shape that is substantially similar to the initial shape.

2. The orthodontic appliance of claim 1 wherein the appliance is an aligner and said polymeric material defines three-dimensional cavities for at least eight teeth of a patient's mandible or maxilla.

3. The orthodontic appliance of claim 1 wherein the appliance will return to a shape that is substantially similar to the initial shape after it has been deformed by over ten days of use.

4. The orthodontic appliance of claim 1 wherein the appliance will return to a shape that is substantially similar to the initial shape after it has been deformed by over two weeks of use.

5. The orthodontic appliance of claim 3 wherein the stress generated by the appliance when deformed from the initial shape is sufficient to cause remodeling of bone adjacent to a tooth's roots when the appliance has been deformed by over two weeks of use.

6. A method of repositioning teeth comprising:
applying an orthodontic appliance to the patient's teeth, the appliance comprising a polymeric material having an initial shape which defines two or more three-dimensional cavities, each said cavity corresponding to the shape of a crown of an individual tooth of the patient's mandible or maxilla, and
deforming the polymeric material by fitting the appliance to the patient's teeth, to generate forces that reposition the patient's teeth,
wherein the polymeric material has the property that after a day of use of the appliance in which it is deformed by fitting the appliance to the patient's teeth, the appliance will return to a shape that is substantially similar to the initial shape.

7. The method of claim 6 wherein the appliance is an aligner and said polymeric material defines three-dimensional cavities for at least eight teeth of a patient's mandible or maxilla.

8. The method of claim 6 wherein the appliance will return to a shape that is substantially similar to the initial shape after it has been deformed by over ten days of use.

9. The method of claim 6 wherein the appliance will return to a shape that is substantially similar to the initial shape after it has been deformed by over two weeks of use.

10. An orthodontic appliance for moving teeth comprising:
a polymeric material having an initial shape which defines two or more three-dimensional cavities, each said cavity corresponding to the shape of the crown of an individual tooth of a patient's mandible or maxilla,
wherein (i) the polymeric material is deformable from said initial shape to a deformed shape when fitted upon a patient's teeth, the polymeric material generating an initial elastic return stress when deformed to said deformed shape, the initial elastic return stress driving the polymeric material from said deformed shape toward said initial shape, and (ii) the polymeric material is capable of generating a continuing elastic return stress driving the polymeric material from said deformed shape toward said initial shape that is at least 25% of the initial elastic return stress after the polymeric material has been deformed to said deformed shape over one day of use.

11. The orthodontic appliance of claim 10 wherein the appliance is an aligner and said polymeric material defines three-dimensional cavities for at least eight teeth of a patient's mandible or maxilla.

12. The orthodontic appliance of claim 10 wherein the polymeric material is capable of generating an ongoing elastic return stress driving the polymeric material from said deformed shape toward said initial shape after the polymeric material has been deformed to said deformed shape over ten days of use.

13. The orthodontic appliance of claim 10 wherein the polymeric material is capable of generating an ongoing elastic return stress driving the polymeric material from said deformed shape toward said initial shape after the polymeric material has been deformed to said deformed shape over twenty days of use.

14. The orthodontic appliance of claim 10 wherein the elastic return stresses generated by the polymeric material upon a tooth crown, are sufficient to cause remodeling of bone adjacent to the tooth's roots after the polymeric material has been deformed to said deformed shape over two weeks of use.

15. The orthodontic appliance of claim 10 wherein the polymeric material is characterized by viscoelastic material properties, and wherein a stress relaxation time of the polymeric material meets or exceeds that required to cause remodeling of bone in the oral environment on or after 10 days.

16. The orthodontic appliance of claim 10 wherein the polymeric material is characterized by viscoelastic material properties and wherein a stress relaxation time of the polymeric material meets or exceeds that required to cause remodeling of bone in the oral environment on or after 20 days.
